(19) United States
(12) Patent Application Publication
(10) Pub. No.: US 2024/0347746 A1
(43) Pub. Date: Oct. 17, 2024

(54) DILUTION CIRCUITRY FOR FUEL CELL VEHICLES WITH COMBINED FUEL CELL EXHAUST SYSTEMS

(71) Applicant: HYDROGENICS CORPORATION, Mississauga (CA)

(72) Inventors: Nader ZAAG, Milton, ON (CA); Sonia SORBERA, Woodbridge, ON (CA)

(21) Appl. No.: 18/573,315

(22) PCT Filed: Jul. 20, 2022
(86) PCT No.: PCT/CA2022/051133

§ 371 Date: Dec. 21, 2023

Related U.S. Application Data
(60) Provisional application No. 63/225,509, filed on Jul. 25, 2021.

(51) Int. Cl. H01M 8/04223; H01M 8/0438; H01M 8/0444; H01M 8/04537; H01M 8/04791

(52) U.S. Cl. CPC H01M 8/04231; H01M 8/0438; H01M 8/0444; H01M 8/04589; H01M 8/04619; H01M 8/04805; H01M 2250/20

(57) ABSTRACT

A method and system includes operating an air blower at an inlet of the fuel cell stack such that a portion of hydrogen in a combined exhaust of a fuel cell system, in all operating conditions of the fuel cell stack, is less than a predefined threshold.

### CROSS-REFERENCE TO RELATED APPLICATIONS

This nonprovisional application claims the benefit and priority, under 35 U.S.C. § 119 (e) and any other applicable laws or statutes, to U.S. Provisional Patent Application Ser. No. 63/225,509 filed on Jul. 25, 2021, the entire disclosure of which is hereby expressly incorporated herein by reference.

### TECHNICAL FIELD

The present disclosure generally relates to methods and systems for controlling dilution of exhaust in a fuel cell system having a combined fuel cell exhaust system.

### BACKGROUND

A ratio of hydrogen that a fuel cell system purges in relation to the amount of air that is delivered to the fuel cell system directly relates to the efficiency and performance of that fuel cell system. When the hydrogen purge system and the air exhaust systems are tied together in a single exhaust, otherwise referred to as a combined exhaust fuel cell system, the ratio of hydrogen to air must be carefully controlled in order to minimize or eliminate a possibility of the mixture of hydrogen and air within the exhaust volume becoming flammable.

The lower flammability limit (LFL) of hydrogen is 4% by volume. Under normal operating conditions, the concentration of hydrogen approaches less than or equal to 50% of LFL. Put another way, under normal operating conditions, concentration of hydrogen within the combined exhaust mixture is less than or equal to 2% by volume. In a failure scenario, with the purge valve driven permanently open, the requirement would be to always remain well under LFL. The margin between the failure scenario concentration and LFL would be dictated by application specific regulators.

In both the normal operating scenario and failure scenario, this entails ensuring the air flow within the combined exhaust system must be sufficient prior to allowing purge of hydrogen into the combined exhaust volume. In one example of an alternative solution, a dedicated dilution fan or blower and a dedicated hydrogen sensor are operating within the exhaust volume or duct. However, adding a dilution fan or blower increases the size and cost of the exhaust system of the fuel cell vehicle. Moreover, the dilution blower or fan subsystem typically includes a motor to operate the blower or fan. Any such motor, along the dilution blower or fan, would be located in the exhaust stream requiring the motor to meet a hazardous area rating, thereby, further increasing its complexity and cost.

The presence of a hydrogen sensor also increases the size and cost of the exhaust system. Depending on an implementation, reliability of hydrogen sensors may be affected by humidity. The exhaust stream of the fuel cell system is heavily humidified (contains water vapor) and the reliability and detectability of the failure of such a sensor would pose additional challenges.

In the case where both of these components would have been added there are additional failure points which adversely impact the reliability and availability of the fuel cell system. The reliability and availability of fuel cell systems is critical as these systems are brought more consistently into everyday use technologies.

A further potential solution for this problem would be the implementation of a positional feedback system on the purge valve. In this case a software lookup would be required in order to ensure that the air flow delivered by the blower or compressor exceeds that required for the existing purge valve position. There are two issues with this strategy. Firstly, it would require the fuel cell system provider to include their software within their safety scope which may not be desired due to resulting implications on the restriction of making further software changes. Secondly, the purge valve not only purges excess hydrogen and inert gases into the exhaust system but also accumulated process water which if not removed can lead to fuel cell stack flooding. A binary control of the purge valve allows the system to take advantage of the water hammer effect in terms of eliminating not only the excess purge gas but also excess water.

### SUMMARY

Embodiments of the present disclosure are included to meet these and other needs.

In one aspect of the present disclosure, described herein, an exhaust system for a fuel cell stack includes a valve, an air flow sensor, and an dilution comparator circuit. The air flow sensor is fluidically coupled upstream from the purge valve. The dilution comparator circuit is communicatively coupled to the air flow sensor and the purge valve. An input voltage value of the dilution comparator circuit is set by a resistor of the dilution comparator circuit. The dilution comparator circuit is configured to digitize an output signal of the air flow sensor, disable the purge valve corresponding to the digitized output signal of the air flow sensor with exhaust air flow during a lockout condition, determine a concentration of hydrogen in the exhaust air flow during the lockout condition, and dilute the air flow sensed by the air flow sensor with at least an air blower of the exhaust system based on the digitized output signal of the air flow sensor in response to the concentration of hydrogen being less than a threshold.

In some embodiments, the digitized output signal of the air flow sensor may be one of a first minimum operating voltage of the air flow sensor and a second minimum operating voltage of the air flow sensor. The second minimum operating voltage may be greater than the first minimum operating voltage.

In some embodiments, the purge valve may vent exhaust output at an outlet of the fuel cell stack when in an open position. In some embodiments, the purge valve may prevent venting of the exhaust output when in a closed position. In some embodiments, the open position of the purge valve may be a fully open position.

In a second aspect of the present disclosure, a fuel cell system includes a fuel cell stack, an air flow sensor, an air blower, a purge valve, and a control logic circuit. The fuel cell stack includes an inlet and an outlet. The air flow sensor and the air blower are fluidically coupled to the inlet. The purge valve is configured to vent exhaust output at the outlet of the fuel cell stack when in an open position, and is configured to prevent venting of the exhaust output when in a closed position. The control logic circuit is configured to determine a first minimum operating power or current, determine a first minimum air flow based on the determine first minimum operating power or current, compare the determined first minimum air flow with a flow rate of hydrogen when the purge valve is in the open position to calculate a concentration of hydrogen, and in response to the concentration of hydrogen resulting from the determined first minimum air flow being less than a threshold, operate the air flow sensor and the air blower according to the determined first minimum operating power or current and the determined first minimum air flow.

In some embodiments, the control logic circuit may be configured to determine a second minimum operating power or current in response to the concentration of hydrogen resulting from the determined first minimum air flow being greater than a threshold. In some embodiments, the second minimum operating power or current is greater than the first minimum operating power or current. In some embodiments, the control logic circuit may be configured to determine a second minimum air flow based on the determined second minimum power or current, compare the determined second minimum air flow with the flow rate of hydrogen when the purge valve is in the open position to calculate the concentration of hydrogen, and in response to the concentration of hydrogen resulting from the determined second minimum air flow being less than a threshold, operate the air flow sensor and the air blower according to the determined second minimum operating power or current and the determined second minimum air flow.

In some embodiments, the open position of the purge valve may be a fully open position.

In some embodiments, the determined first minimum air flow may correspond to the determined first minimum operating power or current of a characteristic curve of the air flow sensor.

In some embodiments, each value operating power or current of the characteristic curve may correspond to a predefined air flow.

In a third aspect of the present disclosure, a method for operating a fuel cell stack includes the steps of determining, by a control logic circuit, a first minimum operating power or current of an air flow sensor, determining a first minimum air flow of based on the determined first minimum operating power or current, comparing the determined first minimum air flow with a flow rate of hydrogen when the purge valve is in the open position to calculate a concentration of hydrogen, and in response to the concentration of hydrogen resulting from the determined first minimum air flow being less than a threshold, operating the air flow sensor and an air blower of a fuel cell exhaust system according to the determined first minimum operating power or current and the determined first minimum air flow. The air flow sensor is coupled at an inlet of the fuel cell stack. The purge valve is configured to vent exhaust output at the outlet of the fuel cell stack when in an open position, and is configured to prevent venting of the exhaust output when in a closed position.

In some embodiments, the air flow sensor and the air blower may be fluidically coupled to the inlet of the fuel cell stack.

In some embodiments, the method may further include determining a second minimum operating power or current in response to the concentration of hydrogen resulting from the determined first minimum air flow being greater than a threshold. In some embodiments, the second minimum operating power or current may be greater than the first minimum operating power or current. In some embodiments, the method may further include determining a second minimum air flow based on the determined second minimum power or current, comparing the determined second minimum air flow with the flow rate of hydrogen when the purge valve is in the open position to calculate the concentration of hydrogen, and in response to the concentration of hydrogen resulting from the determined second minimum air flow being less than a threshold, operating the air flow sensor and the air blower according to the determined second minimum operating power or current and the determined second minimum air flow.

In some embodiments, the open position of the purge valve may be a fully open position.

In some embodiments, the determined first minimum air flow may correspond to the determined first minimum operating power or current of a characteristic curve of the air flow sensor.

In some embodiments, each value operating power or current of the characteristic curve may correspond to a predefined air flow.

### BRIEF DESCRIPTION OF THE DRAWINGS

The detailed description particularly refers to the following figures, in which:

FIG. 1A is an illustration of a fuel cell system including one or more fuel cell stacks connected to a balance of plant;

FIG. 1B is an illustration of components of a fuel cell system including one or more fuel cell modules having one or more fuel cell stacks and/or one or more fuel cells;

FIG. 1C is an illustration of components of a fuel cell in the fuel cell stack;

FIG. 2 is a block diagram illustrating an example process flow for diluting hydrogen in a combined fuel cell exhaust system;

FIG. 3 is a block circuit diagram illustrating an example dilution comparator circuit;

FIG. 4 is a block circuit diagram illustrating an example dilution driver coupling;

FIG. 5 is a block circuit diagram illustrating an example first purge valve implementation;

FIG. 6 is a block circuit diagram illustrating an example second purge valve implementation;

FIG. 7 is a block diagram illustrating an example fuel cell combined exhaust system;

FIG. 8 is a rear view illustrating integrating a mixing point into the fuel cell manifold system or endplate via an integrated purge channel; and

FIG. 9 is a perspective view illustrating an example implementation for transferring a combined exhaust away from the fuel cell stack in a statically dissipating grounded ducting.

### DETAILED DESCRIPTION

The system 200 of the present disclosure relates to monitoring and controlling operation of one or more fuel cell systems 10. More particularly, the system 200 of the present disclosure, as shown in FIG. 3, is configured to monitor and control operation of fuel cell systems 10 including a combined hydrogen purge exhaust and air exhaust 616 in order to ensure that such a system 200 maintains efficiency, performance, and safety over the course of its lifetime.

The system 200 of the present disclosure enables a desired binary control of a purge valve 612, 613 without adding components to the exhaust system 600. The system 200 of the present disclosure is configured to control components already required to operate the fuel cell system 10, such as an air blower 604, a fuel cell stack 12, and a purge valve 612, 613, and details of integration (minimum power rating-minimum air flow rating). The system 200 of the present disclosure is not dependent on the operation of software and would allow the scope of software to remain outside the scope of safety. Furthermore, in one such implementation, it would allow the combining of the hydrogen purge gas 624 and the exhaust gas 622 within the manifold 11 of such a fuel cell system 10.

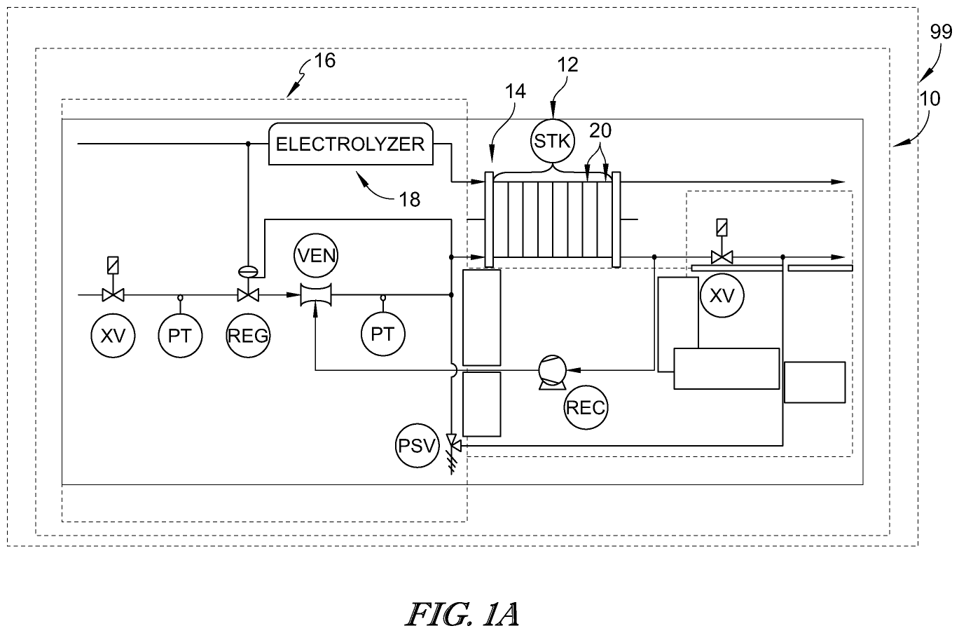

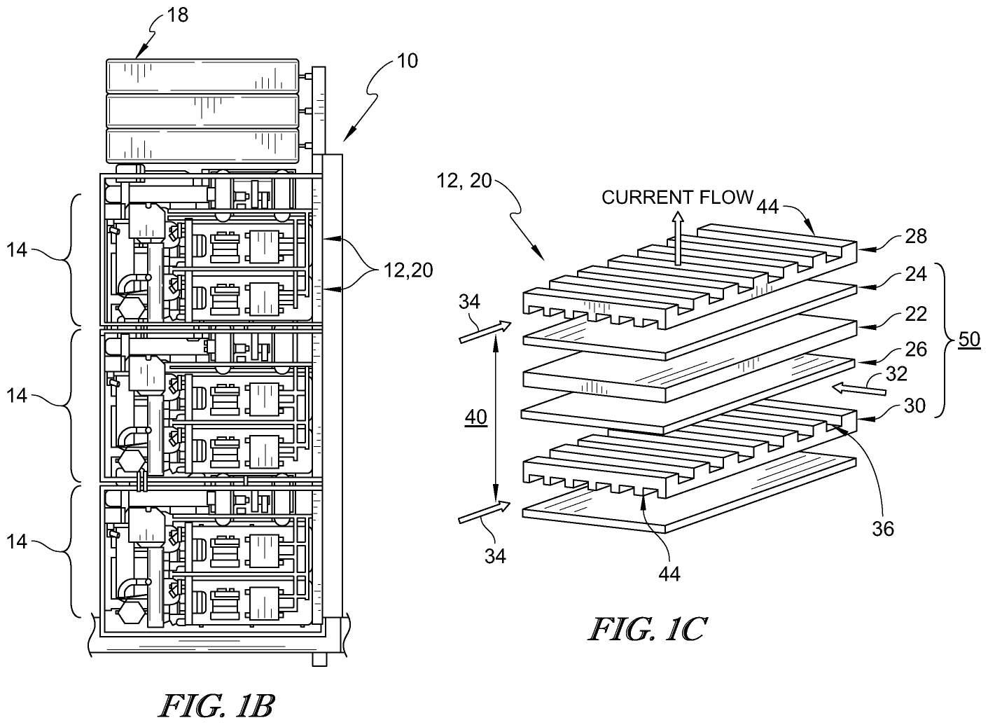

As shown in FIG. 1A, fuel cell systems 10 often include one or more fuel cell stacks 12 or fuel cell modules 14 connected to a balance of plant (BOP) 16, including various components, to create, generate, and/or distribute electrical power for meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 connected together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26. The above mentioned components, 22, 24, 26, 30 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plate (BPP) 28, 30 can uniformly distribute reactants 32, 34 to an active area 40 of each fuel cell 20 through oxidant flow fields 42 and/or fuel flow fields 44. The active area 40, where the electrochemical reactions occur to generate electrical power produced by the fuel cell 20, is centered within the gas diffusion layer (GDL) 24, 26 and the bipolar plate (BPP) 28, 30 at the membrane electrode assembly (MEA) 22. The bipolar plate (BPP) 28, 30 are compressed together to isolate and/or seal one or more reactants 32 within their respective pathways, channels, and/or flow fields 42, 44 to maintain electrical conductivity, which is required for robust during fuel cell 20 operation.

The fuel cell system 10 described herein, may be used in stationary and/or immovable power system, such as industrial applications and power generation plants. The fuel cell system 10 may also be implemented in conjunction with electrolyzers 18 and/or other electrolysis system 18. In one embodiment, the fuel cell system 10 is connected and/or attached in series or parallel to an electrolysis system 18, such as one or more electrolyzers 18 in the BOP 16 (see FIG. 1A). In another embodiment, the fuel cell system 10 is not connected and/or attached in series or parallel to an electrolysis system 18, such as one or more electrolyzers 18 in the BOP 16.

The present fuel cell system 10 may also be comprised in mobile applications. In an exemplary embodiment, the fuel cell system 10 is in a vehicle and/or a powertrain 99. A vehicle 99 comprising the present fuel cell system 10 may be an automobile, a pass car, a bus, a truck, a train, a locomotive, an aircraft, a light duty vehicle, a medium duty vehicle, or a heavy duty vehicle.

The vehicle and/or a powertrain 99 may be used on roadways, highways, railways, airways, and/or waterways. The vehicle 99 may be used in applications including but not limited to off highway transit, bobtails, and/or mining equipment. For example, an exemplary embodiment of mining equipment vehicle 99 is a mining truck or a mine haul truck.

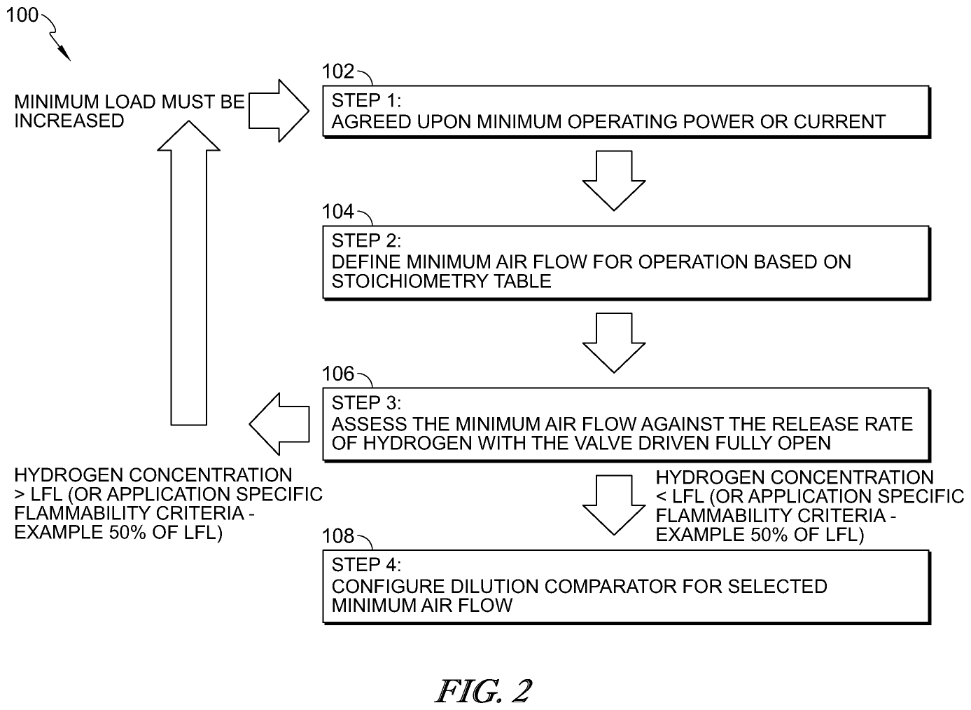

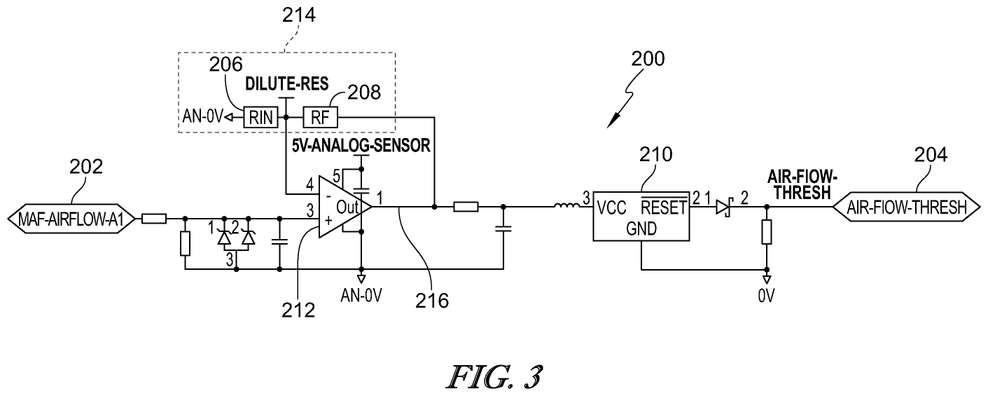

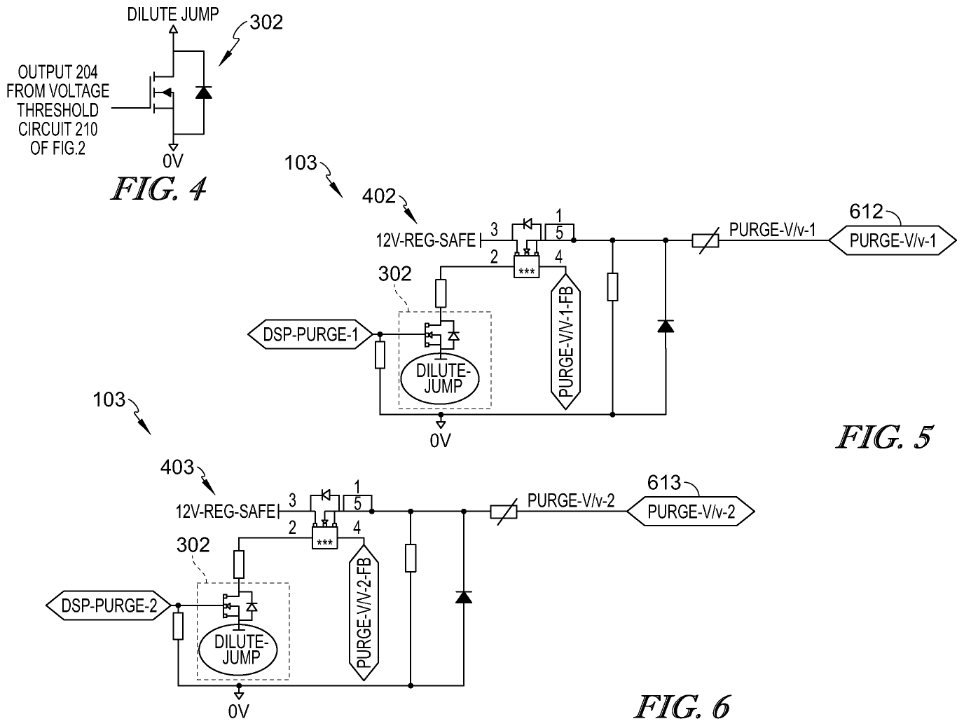

FIG. 2 illustrates an example process flow 100 of the system 200 implemented consistent with the present disclosure. One or more operations of the example process flow 100 may be performed by a control logic circuit, such as the control logic circuit 200 (hereinafter, a dilution comparator circuit 200) described, for example, in reference to FIG. 3. In some instances, the dilution comparator circuit 200 may include a plurality of digital and/or analog components that cooperate in performing one or more operations of the example process flow 100.

At block 102, the dilution comparator circuit 200 causes a system integrator and/or a fuel cell system provider (e.g., a supplier of the fuel cell system) to define and agree upon a minimum power or current of operation. At block 104, the dilution comparator circuit 200 causes the fuel cell system provider to define a minimum air flow of operation, such as using a stoichiometry table. Consideration of both, a minimum power or current operation and a minimum air flow of operation, establishes a minimum amount of air flow and the corresponding minimum power or current of the fuel cell system 10. Conversely, if the fuel cell system 10 is not producing the minimum amount of power or current when being driven with the minimum air flow, the fuel cell system 10 may dry out.

Once the minimum air flow is determined, at block 106, the dilution comparator circuit 200 compares the flow rate, such as a release rate, of hydrogen 32 flowing through the purge valve 612, 613 when driven open to the minimum air flow. Accordingly, the dilution comparator circuit 200 enables diluting hydrogen flow based on the flow rate of hydrogen 32 when the purge valve 612, 613 is driven open as the worst-case scenario will always be at the minimum power when the air flow is the lowest. In response to determining that the application-specific targets have been met, the dilution comparator circuit 200, at block 108, causes the fuel cell system provider to configure the dilution comparator circuit 200 based on the agreed-upon minimum power or current. In response to determining that the targets have not been met, for example, exceed 50% of LFL, the dilution comparator circuit 200 causes the system integrator to increase the agreed-upon minimum load to increase the minimum air flow. The dilution comparator circuit 200 may then repeat operations at blocks 102-106 to determine whether application-specific targets have been met using the new (increased) agreed-upon minimum load.

FIG. 3 illustrates an embodiment of a dilution comparator circuit 200 for performing iterative analysis to determine a minimum power or current corresponding to a predefined minimum air flow. In order to configure the dilution comparator circuit 200, a resultant air flow corresponding to every value of output voltage of the mass air flow sensor 202 may be determined based on a characteristic curve of the mass air flow sensor 202. Accordingly, the fuel cell system provider uses a voltage divider 214 to configure the dilution comparator circuit 200 based on the characteristic curve of the mass air flow sensor 202. The voltage divider 214 includes an input resistor R_{IN} 206 and a feedback resistor RF 208.

A threshold value of the dilution comparator circuit 200 is set by selecting a value of the input resistor R_{IN} 206. The threshold value may be about or less than the lower flammability limit (LFL) of hydrogen, which is about 4% by volume. In some embodiments, the threshold may be 50% of the LFL. The output voltage V_{OUT_OPAMP} 216 of an operational amplifier circuit 212 detected at a voltage threshold circuit 210 is equal to a product between the input voltage value received from the mass air flow sensor 202 and the output voltage of the voltage divider 214, e.g., (1+RF/RN).

$${V}_{OUT \_ OPAMP} = {V}_{MAF} * ( 1 + \frac{{R}_{F}}{{R}_{IN}} ) . \qquad ( 1 )$$

The voltage threshold circuit 210 converts an analog signal indicative of the output voltage V_{OUT_OPAMP} 216 of the operational amplifier circuit 212 to a binary signal that is set to 1 if the voltage from the mass air flow sensor 202 is high enough and is set to 0 if the voltage from the mass air flow sensor 202 is not sufficient. For example, a high enough voltage may be a voltage corresponding to a mass flow measurement from the mass air flow sensors 202 that corresponds to a non-hazardous exhaust based on anode purge rate.

As illustrated in FIG. 4, a digital signal output 204 by the voltage threshold circuit 210 (see FIG. 3) drives an n-channel metal-oxide semiconductor field effect transistor (MOSFET) 302 that electrically couples a drive of the electronic control unit 103 to the purge valve 612, 613 to operate the purge valve 612, 613 to open and close. As illustrated in an example implementation of FIG. 5, the n-channel MOSFET 302 electrically couples a first regulator 402 to a first purge valve 612. Further, as illustrated in an example implementation of FIG. 6, the n-channel MOSFET 302 electrically couples a second regulator 403 to a second purge valve 613. In one example, the signal from the dilution comparator circuit 200 is electrically coupled with the drive signal from other signal drivers. So the signal can be AND-ed (in other words, combined) with any number of other signals that are also used to drive the purge valve(s) such that this signal and any number of others must be activated for the purge valve(s) to be driven. It should be noted that when the air flow condition is not satisfied the ability of the control circuit to drive the purge valve is almost instantaneously removed with the only delay being the reaction time of the operational amplifier, threshold detection circuit, and MOSFETs—the sum of which will typically be well under 100 ms.

While FIGS. 5 and 6 illustrate two purge valves 612, 613, the system 200 of the present disclosure is not so limited. Other implementations may include more or fewer purge valves 612, 613 arranged in similar or different configurations.

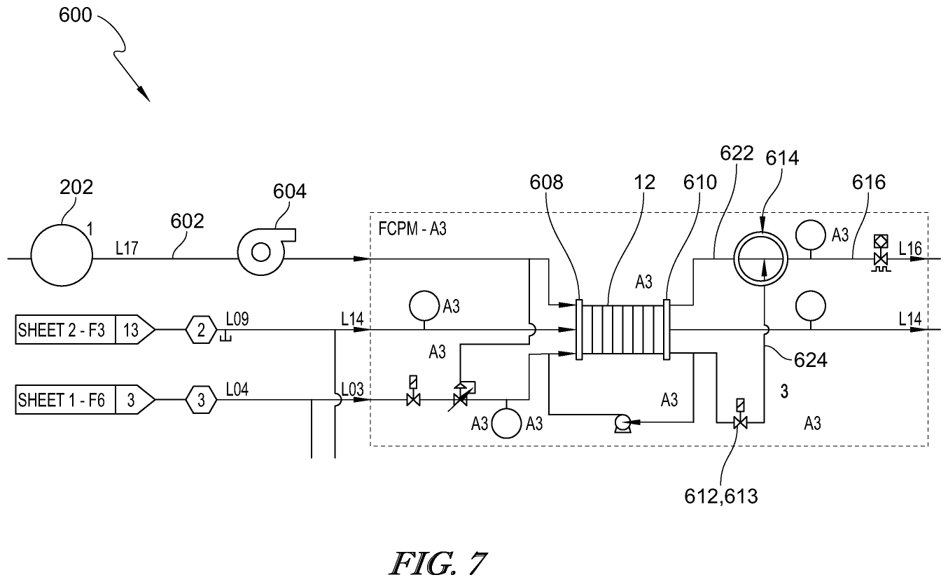

FIG. 7 illustrates an example fuel cell exhaust system 600 including a hydrogen dilution system consistent with the present disclosure. The hydrogen dilution system refers to how the fuel cell exhaust system 600 is controlled with the dilution comparator circuit 200. The fuel cell exhaust system 600 includes a mass air flow sensor 202 (or flow transmitter 202), an air blower or compressor 604, and a fuel cell stack 12. The fuel cell stack 12 includes an inlet 608 and an outlet 610. A given operating voltage of the mass air flow sensor or flow transmitter 202 corresponds to a predefined mass air flow to ensure proper operation of the dilution comparator circuit 200.

The air blower or compressor 604 induces the flow of air 602 through the dilution portion of the exhaust system 600. The air blower or compressor 604 also provides the dilution air flow 602. In particular, the air blower or compressor 604 provides the dilution air flow 602 such that the exhaust of the fuel cell exhaust system 600 is non-hazardous. For example, the air blower or compressor 604 dilutes the air flow 602 at the inlet 608 of the fuel cell stack 12 such that concentration of hydrogen 32 in the exhaust of the fuel cell exhaust system 600 is less than a predefined threshold. Unlike a dedicated dilution fan or blower, the air blower or compressor 604 operates on the inlet 608 of the fuel cell stack 12 and, thus, does not require hazardous area certification. The hazardous area certification may be according to any governmental or jurisdictional standard(s) that may apply. Furthermore, because this blower or compressor 604 provides the required dilution flow it ensures that any component integrated in the combined exhaust system also does not need hazardous area certification.

The fuel cell exhaust system 600 shown in FIG. 7 includes a purge valve 612. The purge valve 612 is operable in a plurality of positions, such as a fully open position, a fully closed position, and one or more intermediate positions achievable when transitioning between the fully open position and the fully closed position. In one example, when in the fully open position, the purge valve 612 is configured to release a predefined maximum exhaust hydrogen flow. The air blower or compressor 604 is configured to dilute the predefined exhaust maximum hydrogen flow such that a concentration of hydrogen 32 in an exhaust mixture output by the fuel cell exhaust system 600 is less than a predefined threshold.

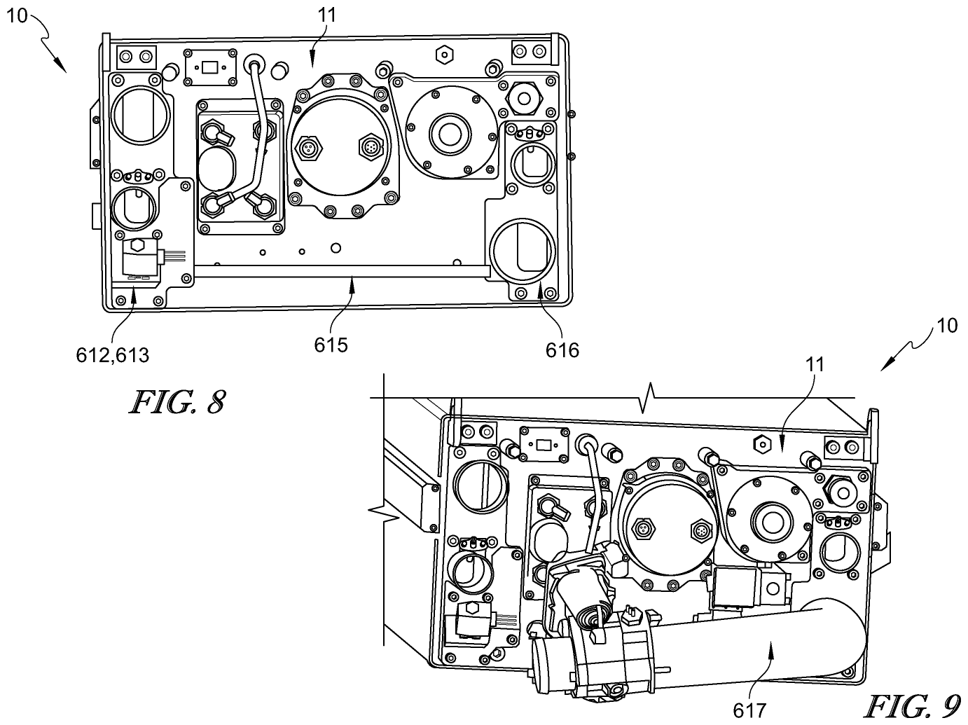

In one example, a mixing point 614 is a fluidic intersection (e.g., a fluidic meeting point) between an air flow exhaust line 622 of the fuel cell exhaust system 600 and a purge valve exhaust line 624 of the fuel cell exhaust system 600. The mixing point 614 may output a combined exhaust mixture 616. In some instances, the mixing point 614 may be integrated directly into the fuel cell manifold system or endplate 11 via an integrated purge channel 615 (FIG. 8). As illustrated in FIG. 9, the combined exhaust 616 may be transferred away from the fuel cell stack 12 in statically dissipating grounded ducting 617. In some embodiments, the dilution system of the present disclosure includes a plurality of thermistor inputs to enable monitoring of critical temperatures. In some embodiments, the fuel cell exhaust system 600 includes only the purge valve 612 and the mixing point 614.

The following described aspects of the present invention are contemplated and non-limiting:

A first aspect of the present invention relates to an exhaust system for a fuel cell stack. The exhaust system includes a purge valve, an air flow sensor, and an dilution comparator circuit. The air flow sensor is fluidically coupled upstream from the purge valve. The dilution comparator circuit is communicatively coupled to the air flow sensor and the purge valve. An input voltage value of the dilution comparator circuit is set by a resistor of the dilution comparator circuit The dilution comparator circuit is configured to digitize an output signal of the air flow sensor, identify exhaust air flow during a lockout condition for disabling the purge valve corresponding to the digitized output of the air flow sensor, determine a concentration of hydrogen in the exhaust air flow during the lockout condition resulting from the digitized output signal of the air flow sensor, and dilute the air flow sensed by the air flow sensor based on the digitized output signal of the air flow sensor in response to the concentration of hydrogen being less than a threshold.

A second aspect of the present invention relates to a fuel cell system including a fuel cell stack, an air flow sensor, an air blower, a purge valve, and a control logic circuit. The fuel cell stack includes an inlet and an outlet. The air flow sensor and the air blower are fluidically coupled to the inlet. The purge valve is configured to vent exhaust output at the outlet of the fuel cell stack when in an open position, and is configured to prevent venting of the exhaust output when in a closed position. The control logic circuit is configured to determine a first minimum operating power or current, determine a first minimum air flow based on the determine first minimum operating power or current, compare the determined first minimum air flow with a flow rate of hydrogen when the purge valve is in the open position to calculate a concentration of hydrogen, and in response to the concentration of hydrogen resulting from the determined first minimum air flow being less than a threshold, operate the air flow sensor and the air blower according to the determined first minimum operating power or current and the determined first minimum air flow.

A third aspect of the present invention relates to a method for operating a fuel cell stack. The method includes the steps of determining, by a control logic circuit, a first minimum operating power or current of an air flow sensor, determining a first minimum air flow of based on the determined first minimum operating power or current, comparing the determined first minimum air flow with a flow rate of hydrogen when the purge valve is in the open position to calculate a concentration of hydrogen, and in response to the concentration of hydrogen resulting from the determined first minimum air flow being less than a threshold, operating the air flow sensor and an air blower of a fuel cell exhaust system according to the determined first minimum operating power or current and the determined first minimum air flow. The air flow sensor is coupled at an inlet of the fuel cell stack. The purge valve is configured to vent exhaust output at the outlet of the fuel cell stack when in an open position, and is configured to prevent venting of the exhaust output when in a closed position.

A fourth aspect of the present invention relates to a method including operating an air blower at an inlet of a fuel cell stack such that a portion of hydrogen in a combined exhaust of a fuel cell system, in all operating conditions of the fuel cell stack, is less than a predefined threshold.

In the first aspect of the present invention, the digitized output signal of the air flow sensor may be one of a first minimum operating voltage of the air flow sensor and a second minimum operating voltage of the air flow sensor. The second minimum operating voltage may be greater than the first minimum operating voltage.

In the first aspect of the present invention, the purge valve may vent exhaust output at an outlet of the fuel cell stack when in an open position. In the first aspect of the present invention, the purge valve may prevent venting of the exhaust output when in a closed position. In the first, second, and third aspect of the present invention, the open position of the purge valve may be a fully open position.

In the second aspect of the present invention, the control logic circuit may be configured to determine a second minimum operating power or current in response to the concentration of hydrogen resulting from the determined first minimum air flow being greater than a threshold. In the second aspect of the present invention, the second minimum operating power or current is greater than the first minimum operating power or current. In the second aspect of the present invention, the control logic circuit may be configured to determine a second minimum air flow based on the determined second minimum power or current, compare the determined second minimum air flow with the flow rate of hydrogen when the purge valve is in the open position to calculate the concentration of hydrogen, and in response to the concentration of hydrogen resulting from the determined second minimum air flow being less than a threshold, operate the air flow sensor and the air blower according to the determined second minimum operating power or current and the determined second minimum air flow.

In the second and third aspect of the present invention, the determined first minimum air flow may correspond to the determined first minimum operating power or current of a characteristic curve of the air flow sensor.

In the second and third aspect of the present invention, each value operating power or current of the characteristic curve may correspond to a predefined air flow.

In the third aspect of the present invention, the air flow sensor and the air blower may be fluidically coupled to the inlet of the fuel cell stack.

In the third aspect of the present invention, the method may further include determining a second minimum operating power or current in response to the concentration of hydrogen resulting from the determined first minimum air flow being greater than a threshold. In the third aspect of the present invention, the second minimum operating power or current may be greater than the first minimum operating power or current. In the third aspect of the present invention, the method may further include determining a second minimum air flow based on the determined second minimum power or current, comparing the determined second minimum air flow with the flow rate of hydrogen when the purge valve is in the open position to calculate the concentration of hydrogen, and in response to the concentration of hydrogen resulting from the determined second minimum air flow being less than a threshold, operating the air flow sensor and the air blower according to the determined second minimum operating power or current and the determined second minimum air flow.

In the fourth aspect of the present invention, operating the air blower may not require the control software of the system to be safety certified. In the fourth aspect of the present invention, the air blower may not be a dedicated dilution blower. The air blower may operate without a hydrogen sensor.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

While the concepts of the present disclosure are susceptible to various modifications and alternative forms, specific exemplary embodiments are been shown by way of example in the drawings and will be described. It should be understood, however, that there is no intent to limit the concepts of the present disclosure to the particular forms disclosed; on the contrary, the intention is to cover all modifications, equivalents, and alternatives falling within the spirit and scope of the invention as defined by the appended claims.

References in the specification to “one embodiment,” “an embodiment,” “an illustrative embodiment,” etc., indicate that the described embodiment may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A combined exhaust system for a fuel cell stack, the combined exhaust system comprising:
a purge valve;
an air flow sensor; and
a dilution comparator circuit communicatively coupled to the air flow sensor and the purge valve, wherein a resistor of the dilution comparator circuit is adapted to set an input voltage value of the dilution comparator circuit, and wherein the dilution comparator circuit is configured to:
digitize a signal reflecting an output voltage of the air flow sensor, wherein the output voltage relates to an air flow detected by the air flow sensor,
open the purge valve,
determine a concentration of hydrogen in the exhaust air flow while the purge valve is open by comparing a flow rate of hydrogen flowing through the purge valve to a predetermined minimum air flow, and
when the concentration of hydrogen in the exhaust air flow is greater than a predefined threshold, dilute the air flow with an air blower at an inlet of the fuel cell so that the concentration of hydrogen in the exhaust air flow is less than the predefined threshold.

2. The exhaust system of claim 1, wherein the digitized output signal of the air flow sensor is one of a first minimum operating voltage of the air flow sensor and a second minimum operating voltage of the air flow sensor, wherein the second minimum operating voltage is greater than the first minimum operating voltage.

3. The exhaust system of claim 1, wherein the purge valve is adapted to vent fuel exhaust output at an outlet of the fuel cell stack when in an open position.

4. The exhaust system of claim 3, wherein the purge valve is adapted to prevent venting of the fuel exhaust output when in a closed position.

5. The exhaust system of claim 3, wherein the open position of the purge valve is a fully open position.

6. A fuel cell system comprising:
a fuel cell stack including an inlet and an outlet;
an air flow sensor fluidically coupled to the inlet;
an air blower fluidically coupled to the inlet;
a purge valve configured to vent fuel exhaust output at the outlet of the fuel cell stack when in an open position, and prevent venting of the fuel exhaust output when in a closed position; and
a control logic circuit configured to:
determine a first minimum operating power or current,
determine a first minimum air flow based on the determined first minimum operating power or current,
compare the determined first minimum air flow with a flow rate of hydrogen when the purge valve is in the open position to calculate a concentration of hydrogen, and
in response to the concentration of hydrogen resulting from the determined first minimum air flow being less than a threshold, operate the air flow sensor and the air blower according to the determined first minimum operating power or current and the determined first minimum air flow.

7. The fuel cell system of claim 6, wherein the control logic circuit is configured to determine a second minimum operating power or current in response to the concentration of hydrogen resulting from the determined first minimum air flow being greater than a threshold.

8. The fuel cell system of claim 7, wherein the second minimum operating power or current is greater than the first minimum operating power or current.

9. The fuel cell system of claim 7, wherein the control logic circuit is configured to:
determine a second minimum air flow based on the determined second minimum power or current,
compare the determined second minimum air flow with the flow rate of hydrogen when the purge valve is in the open position to calculate the concentration of hydrogen, and
in response to the concentration of hydrogen resulting from the determined second minimum air flow being less than a threshold, operate the air flow sensor and the air blower according to the determined second minimum operating power or current and the determined second minimum air flow.

10. The fuel cell system of claim 6, wherein the open position of the purge valve is a fully open position.

11. The fuel cell system of claim 6, wherein the determined first minimum air flow corresponds to the determined first minimum operating power or current of a characteristic curve of the air flow sensor.

12. The fuel cell system of claim 6, wherein each value operating power or current of the characteristic curve corresponds to a predefined air flow.

13. A method for operating a fuel cell stack, the method comprising:
determining, by a control logic circuit, a first minimum operating power or current of an air flow sensor, wherein the air flow sensor is coupled at an inlet of the fuel cell stack, wherein a purge valve is coupled at an outlet of the fuel cell stack, and wherein the purge valve is configured to vent fuel exhaust output at the outlet of the fuel cell stack when in an open position and prevent venting of the fuel exhaust output when in a closed position;
determining a first minimum air flow of based on the determined first minimum operating power or current,
comparing the determined first minimum air flow with a flow rate of hydrogen when the purge valve is in the open position to calculate a concentration of hydrogen, and
in response to the concentration of hydrogen resulting from the determined first minimum air flow being less than a threshold, operating the air flow sensor and an air blower of a fuel cell exhaust system according to the determined first minimum operating power or current and the determined first minimum air flow.

14. The method of claim 13, wherein the air flow sensor and the air blower are fluidically coupled to the inlet of the fuel cell stack.

15. The method of claim 13, further comprising determining a second minimum operating power or current in response to the concentration of hydrogen resulting from the determined first minimum air flow being greater than a threshold.

16. The method of claim 15, wherein the second minimum operating power or current is greater than the first minimum operating power or current.

17. The method of claim 15, further comprising
determining a second minimum air flow based on the determined second minimum power or current,
comparing the determined second minimum air flow with the flow rate of hydrogen when the purge valve is in the open position to calculate the concentration of hydrogen, and
in response to the concentration of hydrogen resulting from the determined second minimum air flow being less than a threshold, operating the air flow sensor and the air blower according to the determined second minimum operating power or current and the determined second minimum air flow.

18. The method of claim 13, wherein the open position of the purge valve is a fully open position.

19. The method of claim 13, wherein the determined first minimum air flow corresponds to the determined first minimum operating power or current of a characteristic curve of the air flow sensor.

20. The method of claim 13, wherein each value operating power or current of the characteristic curve corresponds to a predefined air flow.
